(19) United States
(12) Patent Application Publication
(10) Pub. No.: US 2026/0351802 A1
(43) Pub. Date: Nov. 5, 2026

(54) WIRING MODULE

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Kotaro TAKADA, Osaka (JP); Osamu NAKAYAMA, Osaka (JP); Katsushi MIYAZAKI, Osaka (JP); Daiki TSUJI, Osaka (JP)

(21) Appl. No.: 19/117,407

(22) PCT Filed: Oct. 2, 2023
(86) PCT No.: PCT/JP2023/035903

§ 371 Date: Apr. 1, 2025

(30) Foreign Application Priority Data
Oct. 6, 2022 (JP) 2022-161725

(51) Int. Cl. H01M 50/503; H01M 50/298

(52) U.S. Cl. CPC H01M 50/503; H01M 50/298

(57) ABSTRACT

A wiring module is a wiring module attached to a battery laminate body formed by laminating a plurality of power storage elements each including an electrode terminal, the wiring module including: a plurality of conductive members electrically connected to the electrode terminals, a protector including a first unit and a second unit formed as a separate body from the first unit, the protector holding the plurality of conductive members, and an assembly member, in which the first unit and the second unit are coupled to one another in a slidably movable manner in a lamination direction in which the power storage elements are laminated, the assembly member is assembled with both the first unit and the second unit in a first direction orthogonal to the lamination direction, the first unit, the second unit, and the assembly member each have a facing surface.

### TECHNICAL FIELD

The present disclosure relates to a wiring module.

### BACKGROUND

A high-voltage battery pack used for an electric vehicle or a hybrid vehicle usually has multiple battery cells that are laminated and electrically connected in series or parallel by a wiring module. The battery wiring module described in Patent Document 1 is known, conventionally, as such a wiring module. The battery wiring module described in Patent Document 1 includes a plurality of connection members that connect between electrode terminals of a single battery, and a coupling connection unit made of synthetic resin that houses the plurality of connection members. The coupling connection unit includes a first unit and a second unit that can move with respect to one another in a slidable manner in a direction in which the single battery is laminated. In this way, the battery wiring module of Patent Document 1 can absorb an assembly tolerance between the single battery and the battery wiring module in the direction in which the single battery is laminated.

### PRIOR ART DOCUMENT

### Patent Document

Patent Document 1: JP 2013-016380 A

### SUMMARY OF THE INVENTION

### Problems to be Solved

Incidentally, in the case where a separate member is added to the above configuration, there may be cases in which the separate member is assembled with respect to both the first unit and the second unit. In this case, it can be considered that a sliding movement between the first unit and the second unit is inhibited by the separate member.

### Means to Solve the Problem

A wiring module of the present disclosure is a wiring module to be attached to a battery laminate body formed by laminating a plurality of power storage elements each including an electrode terminal, the wiring module including: a plurality of conductive members electrically connected to the electrode terminals, a protector including a first unit and a second unit formed as a separate body from the first unit, the protector holding the plurality of conductive members, and an assembly member, in which the first unit and the second unit are coupled to one another in a slidably movable manner in a lamination direction in which the power storage elements are laminated, the assembly member is assembled with both the first unit and the second unit in a first direction orthogonal to the lamination direction, the first unit, the second unit, and the assembly member each have a facing surface, the facing surface of the first unit and the facing surface of the assembly member face one another in the first direction, the facing surface of the second unit and the facing surface of the assembly member face one another in the first direction, one of the first unit and the assembly member includes a first projection that projects from the facing surface in the first direction, a first through hole into which the first projection is inserted is formed in the other one of the first unit and the assembly member, one of the second unit and the assembly member includes a second projection that projects from the facing surface in the first direction, a second through hole into which the second projection is inserted is formed in the other one of the second unit and the assembly member, the first projection includes a first contact portion that faces an inner wall of the first through hole in the lamination direction, and a first clearance is set between the first contact portion and the inner wall of the first through hole.

### Effect of the Invention

According to the present disclosure, a wiring module can be provided, the wiring module including a protector that includes a first unit and a second unit that can move with respect to one another in a slidable manner, and an assembly member assembled with both the first unit and the second unit, in which the assembly member allows a sliding movement of the first unit and the second unit.

### BRIEF DESCRIPTION OF THE DRAWINGS

FIG. 1 is a perspective view showing a state where an assembly member is assembled with a protector in a power storage module relating to an embodiment.

FIG. 2 is a perspective view of the power storage module.

FIG. 3 is a front view of the power storage module from which the assembly member has been removed.

FIG. 4 is a front view of the power storage module.

FIG. 5 is a perspective view showing a convex portion and a concave portion disposed on an upper portion of the protector.

FIG. 6 is a perspective view showing a state where the convex portion is housed inside the concave portion on an upper portion of the protector.

FIG. 7 is a perspective view showing a convex portion and a concave portion disposed on a lower portion of the protector.

FIG. 8 is a perspective view of the assembly member.

FIG. 9 is a perspective view of a first projection of the assembly member.

FIG. 10 is a cross-section view of A-A of FIG. 4.

FIG. 11 is a cross-section view of B-B of FIG. 4.

FIG. 12 is a cross-section view of C-C of FIG. 4.

FIG. 13 is a cross-section view of D-D of FIG. 4.

FIG. 14 is a cross-section view schematically showing a first clearance, a second clearance, a third clearance, and a fourth clearance.

FIG. 15 is a perspective view of a front portion of a battery laminate body.

FIG. 16 is a perspective view showing the main parts of a lamination type battery.

### DETAILED DESCRIPTION TO EXECUTE THE INVENTION

### Explanation of the Embodiment of the Present Disclosure

First of all, an embodiment of the present disclosure will be enumerated and described.

(1) A wiring module of the present disclosure is a wiring module to be attached to a battery laminate body formed by laminating a plurality of power storage elements each including an electrode terminal, the wiring module including: a plurality of conductive members electrically connected to the electrode terminals, a protector including a first unit and a second unit formed as a separate body from the first unit, the protector holding the plurality of conductive members, and an assembly member, in which the first unit and the second unit are coupled to one another in a slidably movable manner in a lamination direction in which the power storage elements are laminated, the assembly member is assembled with both the first unit and the second unit in a first direction orthogonal to the lamination direction, the first unit, the second unit, and the assembly member each have a facing surface, the facing surface of the first unit and the facing surface of the assembly member face one another in the first direction, the facing surface of the second unit and the facing surface of the assembly member face one another in the first direction, one of the first unit and the assembly member includes a first projection that projects from the facing surface in the first direction, a first through hole into which the first projection is inserted is formed in the other one of the first unit and the assembly member, one of the second unit and the assembly member includes a second projection that projects from the facing surface in the first direction, a second through hole into which the second projection is inserted is formed in the other one of the second unit and the assembly member, the first projection includes a first contact portion that faces an inner wall of the first through hole in the lamination direction, and a first clearance is set between the first contact portion and the inner wall of the first through hole.

According to such a configuration, by having the first clearance set between the first contact portion of the first projection and the inner wall of the first through hole, the first unit can be slidably moved with respect to the assembly member in the lamination direction. Accordingly, even in the case where the assembly member is assembled with the protector, it is easy to allow the first unit and the second unit to slidably move with respect to one another in the lamination direction.

(2) It is preferable that the assembly member includes the first projection and the second projection, the first through hole is formed in the first unit, and the second through hole is formed in the second unit.

According to such a configuration, since the first unit and the second unit do not include a projection, work of assembling the conductive member with the first unit and the second unit is not hindered.

(3) It is preferable that the second projection includes a second contact portion disposed facing an inner wall of the second through hole in the lamination direction, a second clearance is set between the second contact portion and the inner wall of the second through hole, and the second clearance is smaller than the first clearance.

According to such a configuration, by having the second clearance set to be smaller than the first clearance between the second contact portion of the second projection and the inner wall of the second through hole, it is difficult for the second unit to slidably move with respect to the assembly member in the lamination direction compared to the first unit. In this way, it is easy to position the assembly member with the protector.

(4) It is preferable that the first projection includes a first extension portion that extends from the facing surface in the first direction, and a first enlarged diameter portion that projects from the first extension portion in a direction orthogonal to the first direction, the first enlarged diameter portion being disposed on a tip end portion of the first extension portion, the first enlarged diameter portion includes a first locking portion that locks with a hole edge portion of the first through hole in the first direction, the second projection includes a second extension portion that extends from the facing surface in the first direction, and a second enlarged diameter portion that projects from the second extension portion in a direction orthogonal to the first direction, the second enlarged diameter portion being disposed on a tip end portion of the second extension portion, and the second enlarged diameter portion includes a second locking portion that locks with a hole edge portion of the second through hole in the first direction.

According to such a configuration, by having the first locking portion and the hole edge portion of the first through hole locked together, the first projection can be restrained from falling outside of the first through hole. By having the second locking portion and the hole edge portion of the second through hole locked together, the second projection can be restrained from falling outside of the second through hole.

(5) It is preferable that a direction orthogonal to both the first direction and the lamination direction is set as a second direction, and a dimension of the first through hole in the second direction is smaller than a dimension of the first through hole in the lamination direction.

According to such a configuration, by making a dimension of the first through hole smaller in a second direction orthogonal to the lamination direction that provides the first clearance, the first locking portion and the hole edge portion of the first through hole become easily locked together.

(6) It is preferable that the first enlarged diameter portion projects from the first extension portion in the second direction, and is disposed more inward than the first extension portion in the lamination direction.

According to such a configuration, in the case where the first enlarged diameter portion projects in the lamination direction, it is necessary to increase a projection amount of the first enlarged diameter portion from the first extension portion by the amount of the first clearance. However, in the above configuration, since the first enlarged diameter portion does not project from the first extension portion in the lamination direction, and projects in the second direction, a projection amount of the first enlarged diameter portion from the first extension portion can be reduced, and the first enlarged diameter portion can be made smaller.

(7) It is preferable that the first enlarged diameter portion is a pair of first bending pieces that extend from the first extension portion on both sides in the second direction, and the pair of first bending pieces are elastically deformable in the second direction.

According to such a configuration, the first projection is easily inserted into the first through hole.

(8) It is preferable that the first projection has a first bending space between the pair of first bending pieces, the first bending space allowing the pair of first bending pieces to bend.

According to such a configuration, by having the first bending space provided, the first bending piece becomes easily bent, and furthermore, the first projection becomes easily inserted into the first through hole.

(9) It is preferable that the plurality of conductive members include a busbar, and only one of the first unit and the second unit includes a busbar holding portion that holds the busbar.

Since the busbar in which a large current flows easily generates heat, a material with a high heat resistance is used for the protector that includes the busbar holding portion. According to such a configuration, by using a material with a high heat resistance in only the one of the first unit and the second unit that includes the busbar holding portion, and using an inexpensive material with a normal heat resistance in the other one of the first unit and the second unit that does not include the busbar holding portion, the manufacturing cost of the protector can be reduced.

### DETAILED DESCRIPTION OF THE EMBODIMENT OF THE PRESENT DISCLOSURE

Hereinafter the embodiment of the present disclosure will be described. The present disclosure is not limited to these exemplifications, and it is intended that all modifications, within a meaning and scope equivalent to the scope of the patent claims, shown by the patent claims, are included.

### Embodiment

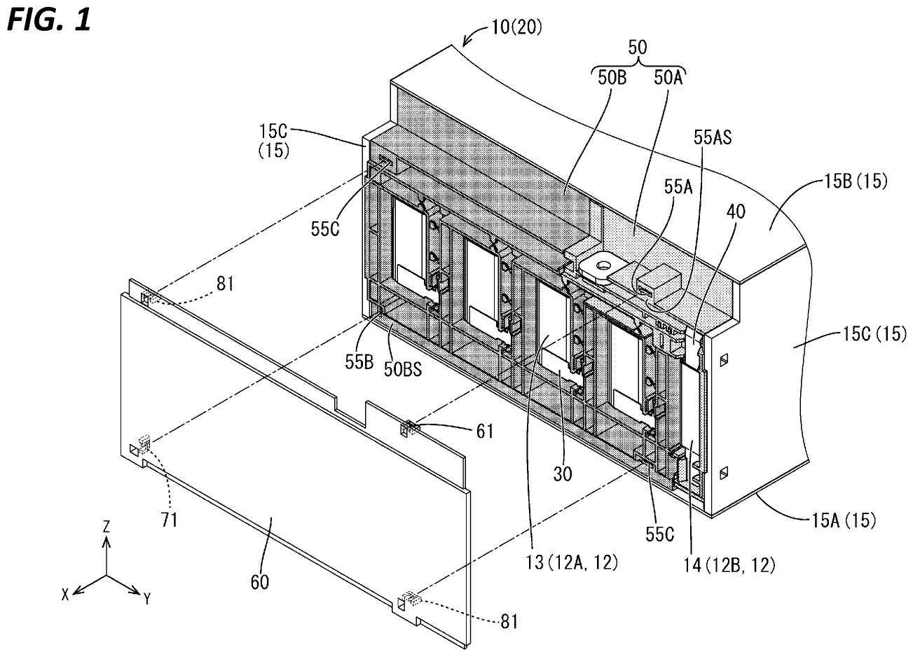

The embodiment of the present disclosure will be described while referring to FIG. 1 to FIG. 16. A power storage module 10 including a wiring module 20 of the present embodiment, for example, is mounted in a vehicle such as an electric vehicle or a hybrid vehicle, and is used as a drive source of the vehicle. In the following description, for a plurality of same reference numerals, there may be cases in which reference numerals are only attached to a part of the members, and reference numerals of the other members are omitted. Hereinafter, a description will be performed with the direction shown by arrow X as the front, the direction shown by arrow Y as the left, and the direction shown by arrow Z as above. In the present embodiment, the left-right direction is an example of a lamination direction, the front-rear direction is an example of a first direction, and the up-down direction is an example of a second direction.

### Battery Laminate Body

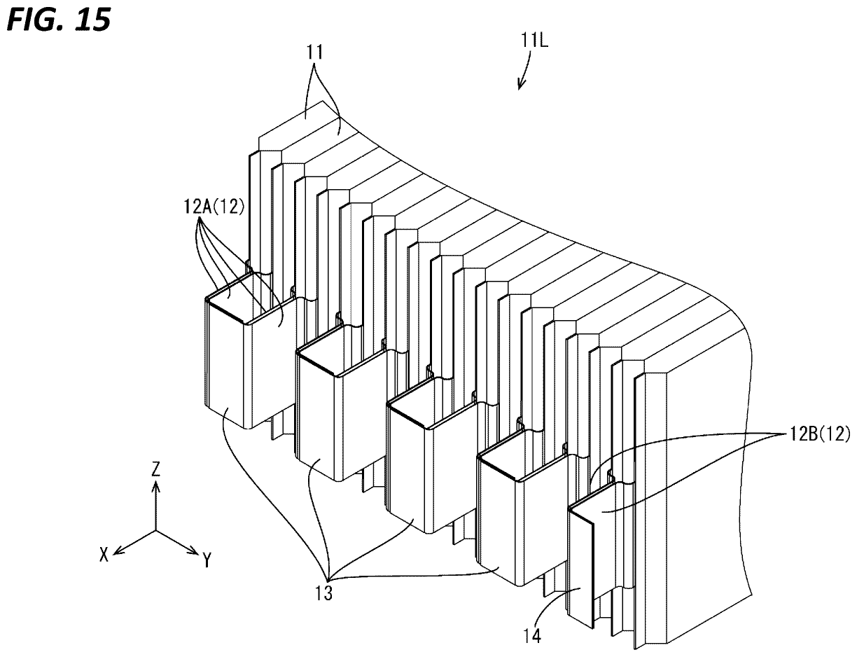

The power storage module 10 includes a battery laminate body 11L, which is shown in FIG. 15, and a wiring module 20 attached to the battery laminate body 11L, which is shown in FIG. 1. As shown in FIG. 1, the power storage module 10 of the present embodiment further includes a casing 15 that covers the battery laminate body 11L from the four directions of up-down and left-right. The casing 15 is formed by a bottom portion 15A disposed on a lower surface side of the battery laminate body 11L, a ceiling portion 15B disposed on an upper surface side of the battery laminate body 11L, and a pair of side portions 15C that connect the bottom portion 15A and the ceiling portion 15B on both the left and right sides.

### Lamination Type Battery, Electrode Lead

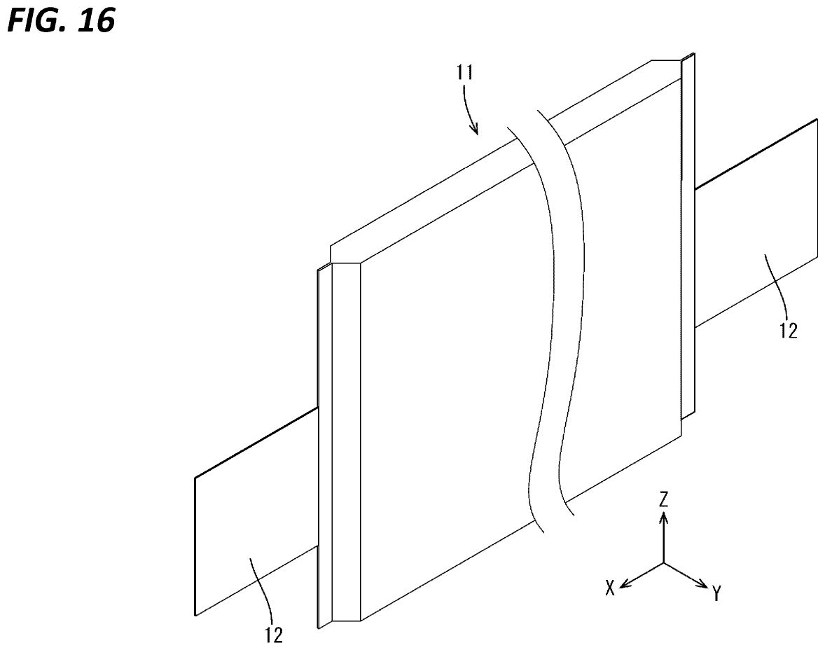

As shown in FIG. 15, the battery laminate body 11L is configured by having a plurality (18 in the present embodiment) of lamination type batteries 11 (an example of battery storage elements) laminated in a lamination direction (left-right direction). Note that, in FIG. 15, only the front side portion of the battery laminate body 11L is shown. As shown in FIG. 16, the lamination type battery 11 is long in the front-rear direction, and has a flat shape in the left-right direction. A power storage element (not illustrated) is housed inside the lamination type battery 11. A pair of electrode leads 12 (an example of electrode terminals) are disposed on both sides of the lamination type battery 11 in the front-rear direction, and project so as to mutually face opposing directions. Each of the pair of electrode leads 12 has a plate shape, and has a mutually opposite polarity.

### Joint Portion

As shown in FIG. 15, joint portions 13, which are each the four electrode leads 12 of each of the lamination type batteries 11 continuously lined up in the left-right direction being electrically connected, are provided in the battery laminate body 11L. Namely, the joint portions 13 are each configured by having the four electrode leads 12 bent at a substantially right angle to the left or the right, and joined by laser welding by being superimposed on one another. The electrode leads 12 constituting each of the joint portions 13 are set as connection electrode leads 12A. From among the four connection electrode leads 12A, the two connection electrode leads 12A disposed on the right side and the two connection electrode leads 12A disposed on the left side have opposite polarities. For example, the two connection electrode leads 12A on the right side are set as positive electrodes, and the two connection electrode leads 12A on the left side are set as negative electrodes. Therefore, in the battery laminate body 11L, each of the joint portions 13 connects in series two of the lamination type batteries 11 that are connected in parallel. The battery laminate body 11L includes four of the joint portions 13 on a front portion. Note that, while not illustrated, the battery laminate body 11L also includes four of the joint portions 13 on a rear portion.

The battery laminate body 11L includes an output portion 14 on a left end portion of the front portion. Note that, while not illustrated, the battery laminate body 11L also includes the output portion 14 on a right end portion of the rear portion. The output portion 14 is configured by joining two of the electrode leads 12 that do not constitute the joint portions 13, from among the electrode leads 12. The electrode leads 12 constituting the output portion 14 are set as output electrode leads 12B. The two output electrode leads 12B constituting the one output portion 14 have a same polarity. The output portion 14 constitutes a positive electrode or a negative electrode of the entire battery laminate body 11L. Namely, for example, in the case where the output portion 14 of the front portion is an overall positive electrode of the battery laminate body 11L, the output portion 14 of the rear portion will be an overall negative electrode of the battery laminate body 11L.

### Wiring Module

As shown in FIG. 1, the wiring module 20 of the present embodiment includes terminals 30 connected to the connection electrode leads 12A, a busbar 40 connected to the output electrode leads 12B, a protector 50 that holds the terminals 30 and the busbar 40, and an assembly member 60 assembled with the protector 50. Note that, the terminals 30 and the busbar 40 are each an example of a conductive member. Hereinafter, the configuration of the wiring module 20 disposed on the front side of the power storage module 10 will be described in detail. While not illustrated, the wiring module 20 disposed on the rear side of the power storage module 10 is configured similar to the wiring module 20 disposed on the front side of the power storage module 10.

### Busbar

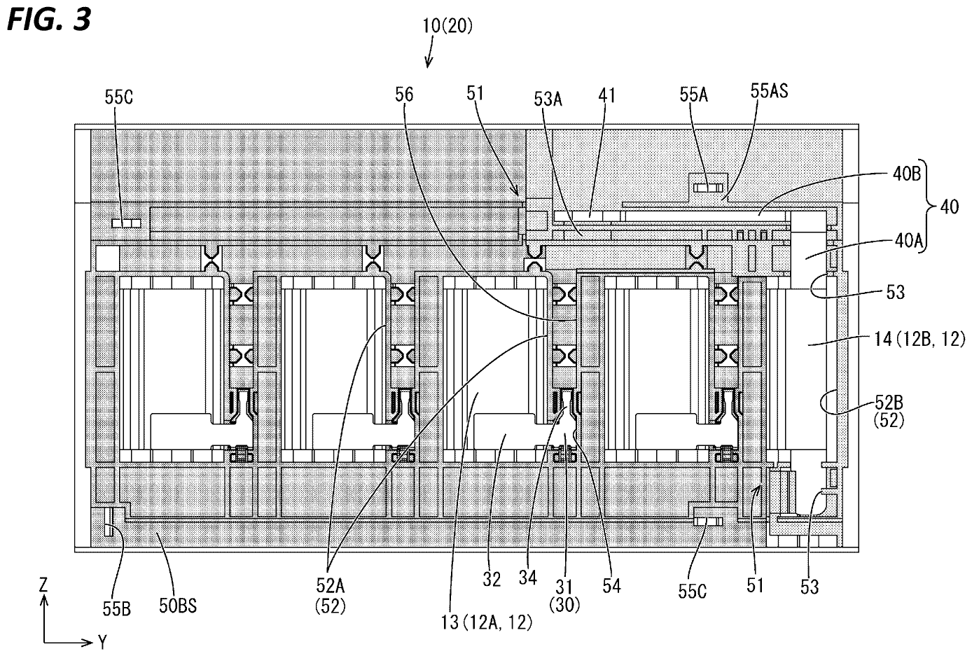

The busbar 40 has a plate type shape, and is formed by adding an electrically conductive metal plate material. As shown in FIG. 3, the busbar 40 includes a first portion 40A that extends in the up-down direction, and a second portion 40B connected to an upper end portion of the first portion 40A. The first portion 40A is set to be flat in the front-rear direction. The second portion 40B extends to the right from the upper end portion of the first portion 40A, and is set to be flat in the up-down direction. The busbar 40 is held by a busbar holding portion 53 of the protector 50 (first unit 50A), and is connected to the output electrode leads 12B at a center portion of the first portion 40A in the up-down direction. A busbar side connection portion 41 is provided on the right end portion of the second portion 40B.

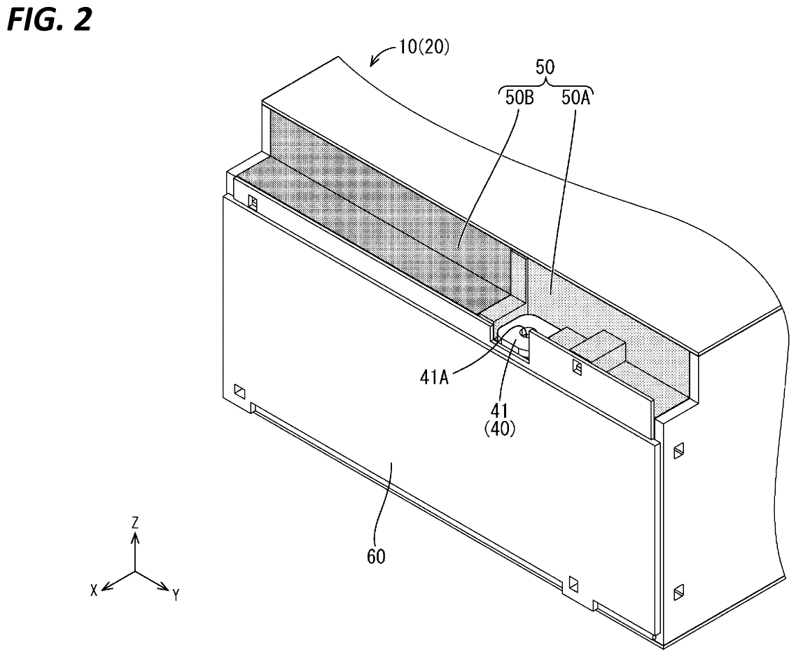

As shown in FIG. 2, the busbar side connection portion 41 has an insertion hole 41A into which a bolt is inserted. An external connection terminal, which is not illustrated, is superimposed on the busbar side connection portion 41, and is fastened by bolts to the busbar side connection portion 41. In this way, the busbar side connection portion 41 is electrically connected to the external connection terminal. The external connection terminal is used for connecting an external device, which is not illustrated, and the power storage module 10.

### Terminal

The terminals 30 are each provided by adding an electrically conductive metal plate material. As shown in FIG. 3, the terminals 30 each include a main body portion 31, a connection portion 32 that extends to the right from the main body portion 31, and a wiring connection portion 34 that extends above from the main body portion 31. The main body portion 31 is housed and held in a terminal housing portion 54 of the protector 50. The connection portion 32 is set as a connected state by making surface contact with the joint portion 13 or a part of the connection electrode leads 12A constituting the joint portion 13. Namely, the terminals 30 are not members for connecting adjacent connection electrode leads 12A, but are members for connecting between pre-connected connection electrode leads 12A (joint portion 13) and an electrical wire (not illustrated).

The wiring connection portion 34 has a crimped piece that is crimped to the electrical wire. The electrical wire connected to the terminal 30 by the wiring connection portion 34 is wired to a wiring concave portion 56 of the protector 50, and is wired at a predetermined position. The electrical wire is connected to an external Electronic Control Unit (ECU) via a connector or the like (not illustrated). The ECU is mounted with a microcomputer, element or the like, and has a well-known configuration that includes a function for performing detection of a voltage, current, temperature or the like of each of the lamination type batteries 11, and a charge/discharge control of each of the lamination type batteries 11.

### Protector, First Unit, Second Unit

The protector 50 is formed from an insulating synthetic resin, and has a plate shape. As shown in FIG. 1, the protector 50 is positioned with respect to the casing 15 (and the battery laminate body 11L). The protector 50 is configured by a first unit 50A, and a second unit 50B of a separate body from the first unit 50A. The first unit 50A constitutes a left-side portion of the protector 50, and the second unit 50B constitutes a right-side portion of the protector 50. The first unit 50A and the second unit 50B are capable of moving with respect to one another in a slidable manner in the left-right direction. In this way, an assembly tolerance between the protector 50 and the battery laminate body 11L can be absorbed. Moreover, the protector 50 can follow an expansion or contraction of the battery laminate body 11L in the lamination direction by the use of the power storage module 10.

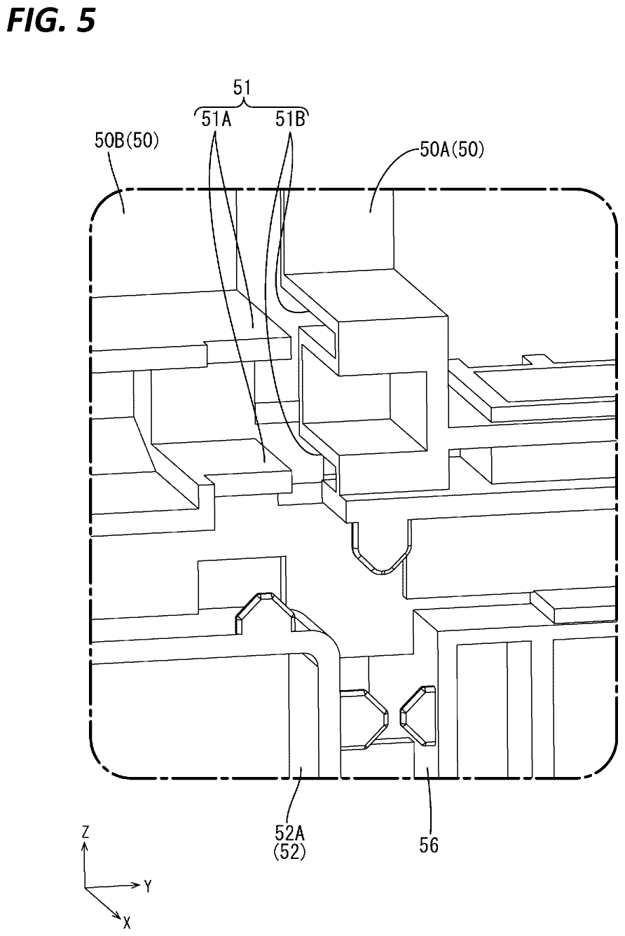

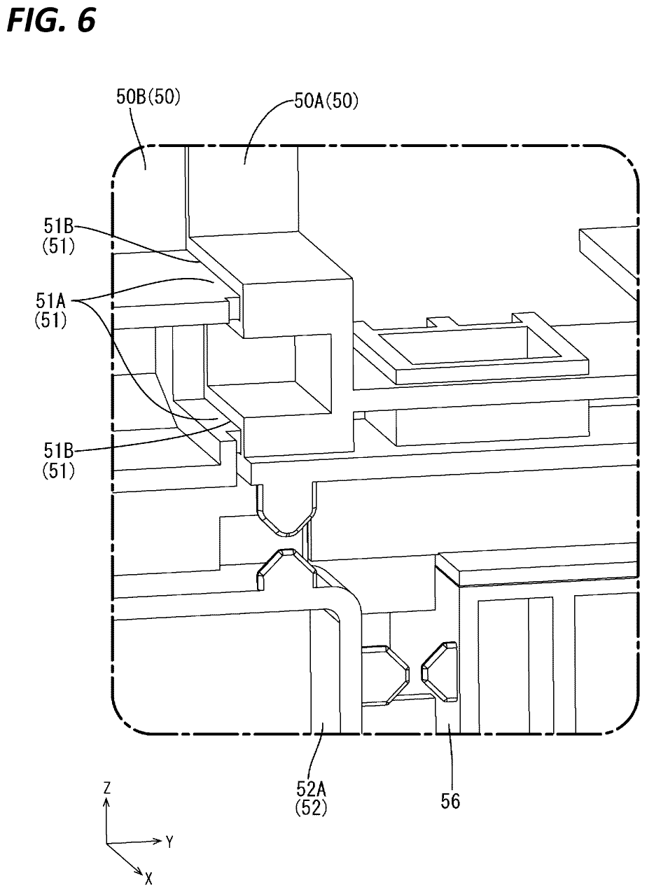

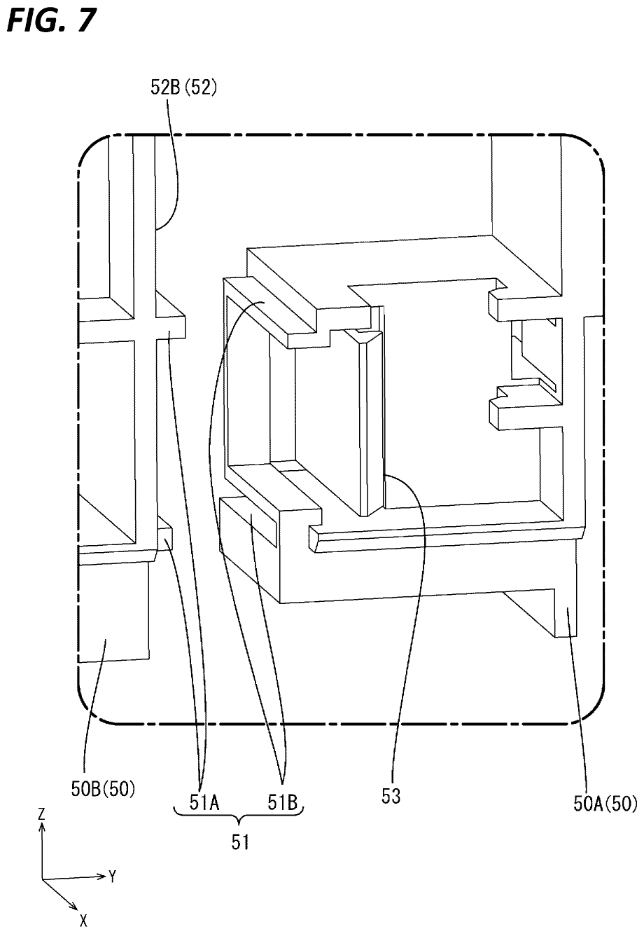

Specifically, as shown in FIG. 3, the first unit 50A and the second unit 50B each include a slide structure 51. This slide structure 51 is provided at the position of an upper portion and near a left-right center of the protector 50 (refer to FIG. 5 and FIG. 6) and at the position of a lower portion and in the vicinity of a left end portion of the protector 50 (refer to FIG. 7). As shown in FIG. 5 to FIG. 7, the slide structure 51 is configured by including a convex portion 51A, and a concave portion 51B capable of being housed inside the convex portion 51A. The slide structure 51 is designed so that the first unit 50A and the second unit 50B are capable of moving relative to one another in the left-right direction only by the amount of a predetermined length, in a state where the convex portion 51A is housed inside the concave portion 51B.

As shown in FIG. 3, electrode housing concave portions 52 are provided, in parallel in the left-right direction, in a central portion of the protector 50 in the up-down direction. The electrode housing concave portions 52 are each formed through the front-rear direction, and each have a vertically long rectangular shape. The electrode housing concave portions 52 are each configured by a connection electrode housing concave portion 52A that receives the joint portions 13 and the connection electrode leads 12A, and an output electrode housing concave portion 52B that receives the output electrode leads 12B and the output portions 14. The connection electrode housing concave portion 52A is provided in the first unit 50A. The output electrode housing concave portion 52B is configured by an end edge of the first unit 50A and an end edge of the second unit 50B.

In the first unit 50A, busbar holding portions 53, which hold the busbar 40, are provided on an upper side and a lower side of the output electrode housing concave portion 52B. A bolt fastening portion 53A for fastening the busbar 40 by bolts is provided on the right side of the upper-side busbar holding portion 53. Terminal housing portions 54, which each house the main body portion 31 of one of the terminals 30, are provided on a lower side in a left-diagonal direction with respect to the connection electrode housing concave portion 52A of the second unit 50B.

In the present embodiment, the first unit 50A, which holds the busbar 40, includes a high heat resistance. Moreover, the first unit 50A has a high strength, in order to provide the bolt fastening portion 53A in the first unit 50A. Different to the first unit 50A, which requires such a high heat resistance and high strength, a resin material having a lower heat resistance and strength than the material of the first unit 50A may be used for the second unit 50B. In this way, the manufacturing cost of the protector 50 can be reduced.

### First Through Hole

As shown in FIG. 1 and FIG. 3, a first through hole 55A, into which the first unit 50A passes through in the front-rear direction, is formed in an upper portion and a left-right center of the first unit 50A. The first through hole 55A is provided on a front surface 50AS (an example of a facing surface) of the first unit 50A. The first through hole 55A has a rectangular shape in a front view. The dimension of the first through hole 55A in the left-right direction is larger than the dimension of the first through hole 55A in the up-down direction.

### Second Through Hole

A second through hole 55B, into which the second unit 50B passes through in the front-rear direction, is formed in a lower portion and in the vicinity of a right end portion of the second unit 50B. The second through hole 55B is provided in a front surface 50BS (an example of a facing surface) of the second unit 50B. The second through hole 55B has a rectangular shape in a front view. The dimension of the second through hole 55B in the left-right direction is smaller than the dimension of the second through hole 55B in the up-down direction.

Third through holes 55C, into which the second unit 50B passes through in the front-rear direction, are formed at the position of an upper portion and in the vicinity of a right end portion of the second unit 50B and at the position of a lower portion and in the vicinity of a left end portion of the second unit 50B. The third through holes 55C are each provided in a front surface 50BS of the second unit 50B. The third through holes 55C each have a rectangular shape in a front view. The dimension of each of the third through holes 55C in the left-right direction is larger than the dimension of each of the third through holes 55C in the up-down direction. The third through holes 55C are each formed with the same dimensions as the dimensions of the first through hole 55A.

### Assembly Member

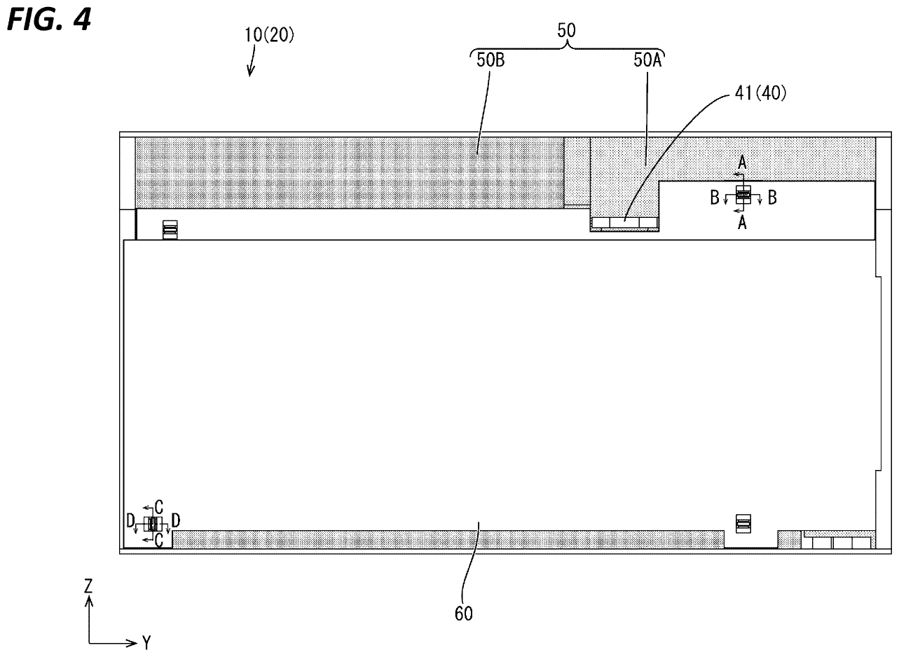

The assembly member 60 is formed from an insulating synthetic resin, and has a plate shape. As shown in FIG. 1, FIG. 2, and FIG. 4, the assembly member 60 is assembled with both the first unit 50A and the second unit 50B in the front-rear direction. In the present embodiment, the assembly member 60 is assembled with the protector 50 from the front, and is set as a cover that covers all of the terminals 30 and a part of the busbar 40.

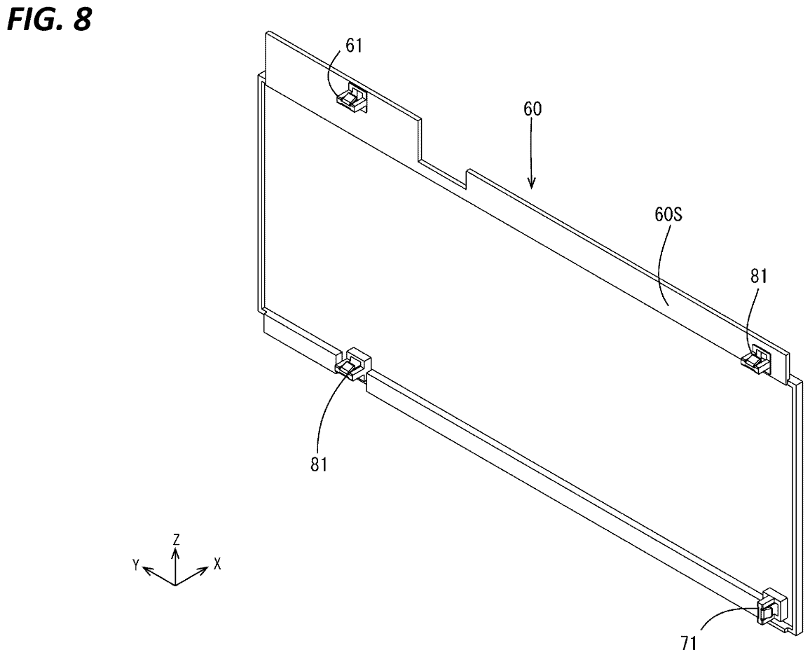

As shown in FIG. 1 and FIG. 8, the assembly member 60 includes a first projection 61, a second projection 71, and third projections 81 that each project to the rear from a rear surface 60S (an example of a facing surface) of the assembly member 60. The first projection 61 is disposed on an upper left portion of the assembly member 60. The second projection 71 is disposed on a lower right portion of the assembly member 60. The third projections 81 are disposed on a lower left portion and an upper right portion of the assembly member 60. As shown in FIG. 1, the first projection 61, the second projection 71, and the third projections 81 are inserted into the first through hole 55A, the second through hole 55B, and the third through holes 55C, respectively.

### First Projection, First Extension Portion, First Contact Portion

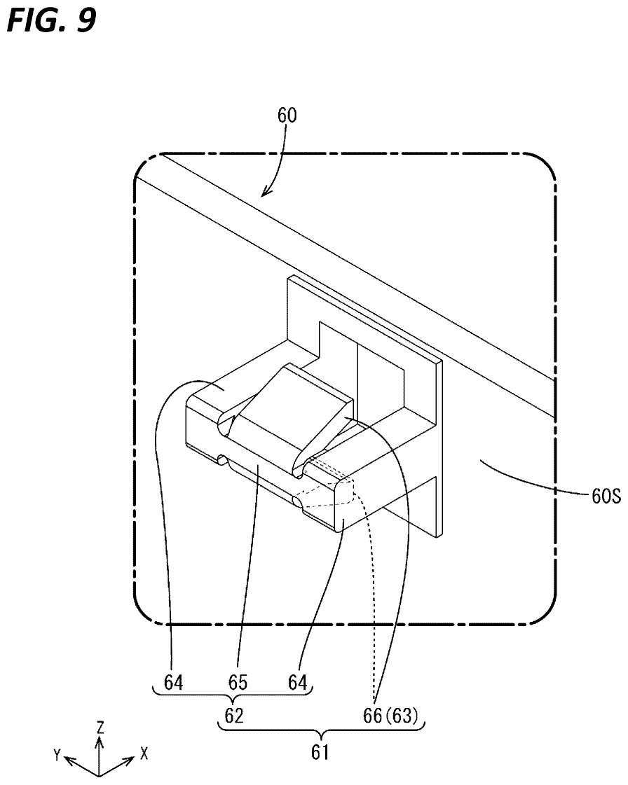

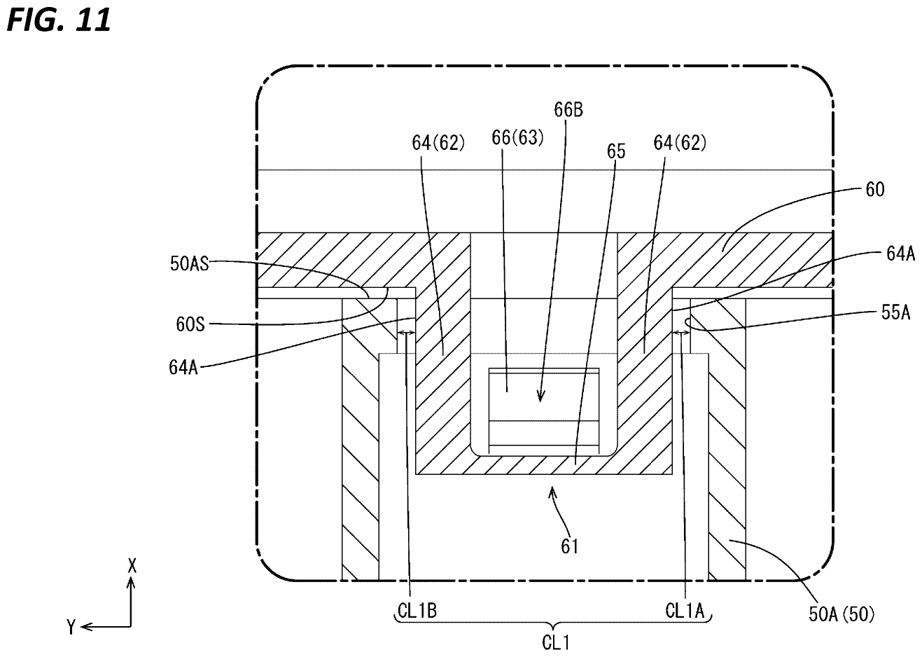

As shown in FIG. 9, the first projection 61 includes a first extension portion 62 that extends to the rear from the rear surface 60S of the assembly member 60, and a first enlarged diameter portion 63 disposed on a tip end portion (rear end portion) of the first extension portion 62. The first extension portion 62 includes two first column portions 64, and a first beam portion 65 that connects rear end portions of the two first column portions 64. The two first column portions 64 are disposed in a row in the left-right direction. As shown in FIG. 11, the first column portion 64 is disposed inside the first through hole 55A, and includes a first contact portion 64A that faces an inner wall of the first through hole 55A in the left-right direction.

### First Enlarged Diameter Portion, Pair of First Bending Pieces

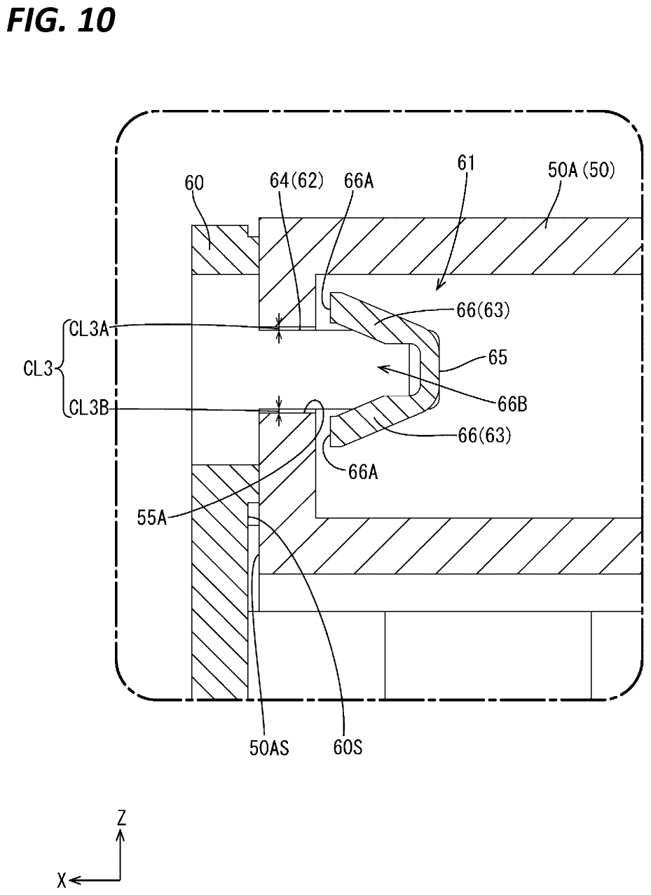

As shown in FIG. 9, the first enlarged diameter portion 63 projects above and below from the first beam portion 65 of the first extension portion 62. The first enlarged diameter portion 63 is disposed between the two first column portions 64, and is disposed more inward than the first extension portion 62 in the left-right direction. As shown in FIG. 10, the first enlarged diameter portion 63 is set as a pair of first bending pieces 66 that are capable of being bent and deformed in the up-down direction. The first bending piece 66 disposed on an upper side of the first beam portion 65 extends upward and to the front from the first beam portion 65. The first bending piece 66 disposed on a lower side of the first beam portion 65 extends downward and to the front from the first beam portion 65. A tip end portion (front end portion) of each of the first bending pieces 66 is set as a first locking portion 66A. The first locking portion 66A is set as a substantially parallel surface with the rear surface 60S of the assembly member 60.

### First Bending Space

A first bending space 66B, in which the first bending pieces 66 can enter by being bent and deformed, is provided between the pair of first bending pieces 66. As shown in FIG. 11, the first bending space 66B is provided between the two first column portions 64.

### Assembly of the First Projection to the First Through Hole

When the first projection 61 is inserted into the first through hole 55A, the front surface 50AS of the first unit 50A and the rear surface 60S of the assembly member 60 are disposed so as to face one another, and the first unit 50A and the assembly member 60 are brought close to one another. The first enlarged diameter portion 63 engages with the inner wall of the first through hole 55A, and the pair of first bending pieces 66 are bent and deformed. The first enlarged diameter portion 63 enters inside the first through hole 55A, by having the upper-side first bending piece 66 enter the first bending space 66B by being bent downward and having the lower-side first bending piece 66 enter the first bending space 66B by being bent upward. When the first enlarged diameter portion 63 moves to the front of the first through hole 55A, the pair of first bending pieces 66 return to a natural state (refer to FIG. 10). The first locking portion 66A on the tip end portion of each of the first bending pieces 66 is disposed facing the hole edge portion of the first through hole 55A of the first unit 50A, and is capable of being locked with the hole edge portion of the first through hole 55A. Therefore, the first projection 61 is prevented from falling out in a state where inserted into the first through hole 55A.

### First Clearance

As shown in FIG. 11, a first clearance CL1 is set between the first contact portion 64A and the inner wall of the first through hole 55A facing the first contact portion 64A, in a state where the first projection 61 is inserted into the first through hole 55A. In detail, the first clearance CL1 combines a right-side first clearance CL1A provided between the first contact portion 64A on the right side and the inner wall of the first through hole 55A on the right side, and a left-side first clearance CL 1B provided between the first contact portion 64A on the left side and the inner wall of the first through hole 55A on the left side. By providing the first clearance CL1, the first unit 50A can be moved in the left-right direction only by the amount of the first clearance CL1 with respect to the assembly member 60. Therefore, the first unit 50A is allowed to slidably move in the left-right direction with respect to the second unit 50B.

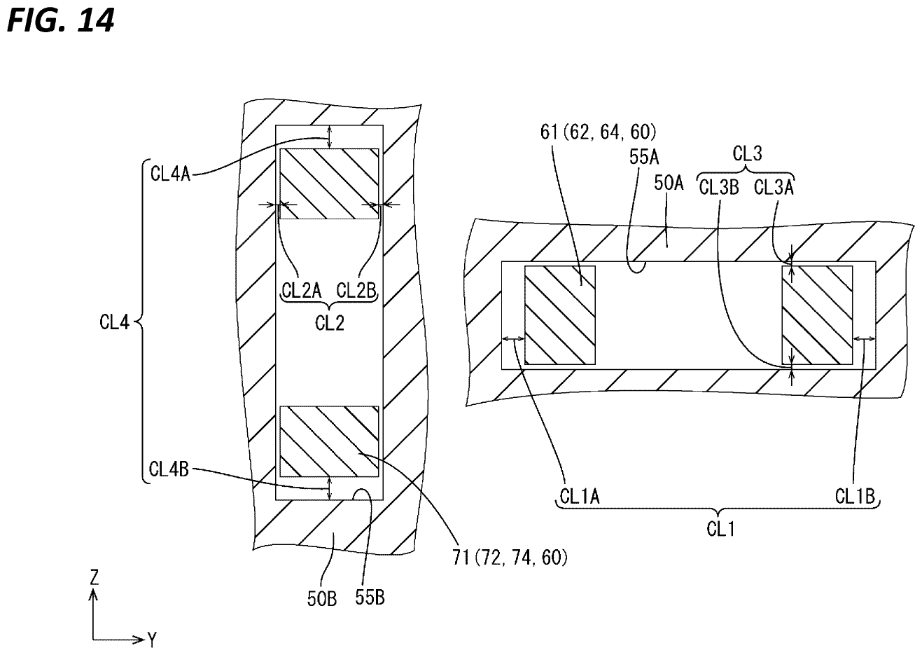

As shown in FIG. 10, a third clearance CL3 is provided, in the up-down direction, between the first extension portion 62 and the first through hole 55A. In detail, an upper-side third clearance CL3A is provided between an upper surface of the first extension portion 62 and the inner wall of the first through hole 55A on the upper side. A lower-side third clearance CL3B is provided between a lower surface of the first extension portion 62 and the inner wall of the first through hole 55A on the lower side. The third clearance CL3 combines the upper-side third clearance CL3A and the lower-side third clearance CL3B. As shown in FIG. 14, the third clearance CL3 is set to be small compared to the first clearance CL1. Accordingly, it becomes difficult for the first unit 50A to move in the up-down direction compared to the left-right direction with respect to the assembly member 60.

### Third Projection

As shown in FIG. 8, since the third projections 81 are each configured similar to the first projection 61, a detailed description will be omitted. A comparatively large clearance with a size the same as the size of the first clearance CL1 is provided in the left-right direction, and a comparatively small clearance with a size the same as the size of the third clearance CL3 (set as a fifth clearance) is provided in the up-down direction, between each of the third projections 81 and each of the third through holes 55C (refer to FIG. 14).

### Second Projection, Second Extension Portion, Second Contact Portion

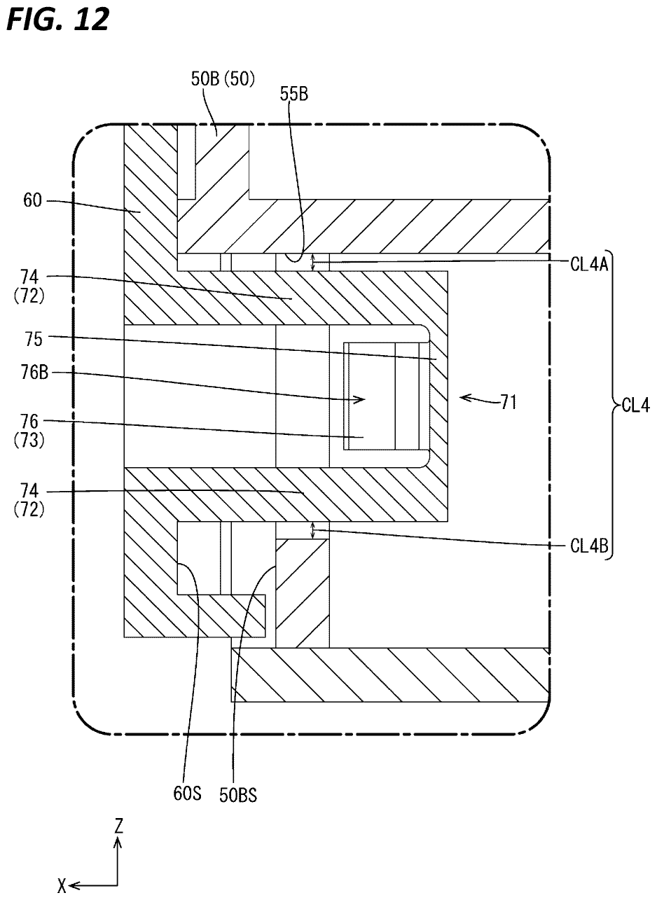

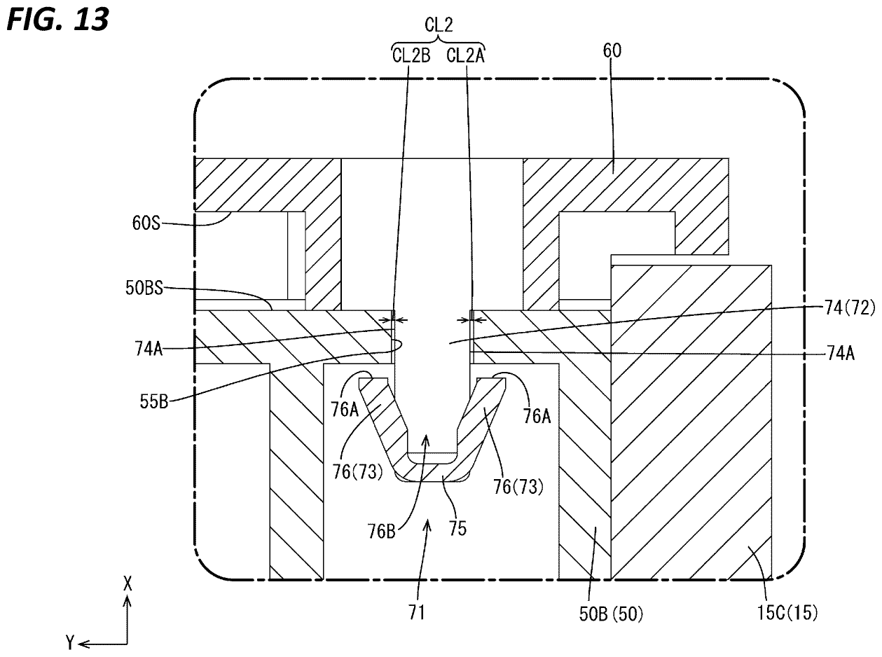

As shown in FIG. 8, the second projection 71 has a structure in which the first projection 61 is rotated 90° with respect to an axis extending in the front-rear direction. As shown in FIG. 13, the second projection 71 includes a second extension portion 72 and a second enlarged diameter portion 73. As shown in FIG. 12, the second extension portion 72 includes two second column portions 74 lined up in the up-down direction, and a second beam portion 75 that connects the rear end portions of the second column portions 74. As shown in FIG. 13, the second column portions 74 are each disposed inside the second through hole 55B, and each includes a second contact portion 74A facing the inner wall of the second through hole 55B in the left-right direction.

### Second Enlarged Diameter Portion, Second Locking Portion

The second enlarged diameter portion 73 is set as a pair of second bending pieces 76 that are capable of being bent and deformed in the left-right direction. The second bending piece 76 disposed on a right side of the second beam portion 75 extends to the right and to the front from the second beam portion 75. The second bending piece 76 disposed on a left side of the second beam portion 75 extends to the left and to the front from the second beam portion 75. A tip end portion (front end portion) of each of the second bending pieces 76 is set as a second locking portion 76A. A second bending space 76B, into which each of the second bending pieces 76 can enter by being bent and deformed, is provided between the pair of second bending pieces 76.

### Second Clearance

A second clearance CL2 is set between the second contact portion 74A and the inner wall of the second through hole 55B facing the second contact portion 74A, in a state where the second projection 71 is inserted into the second through hole 55B. In detail, the second clearance CL2 combines a right-side second clearance CL2A provided between the second contact portion 74A on the right side and the inner wall of the second through hole 55B on the right side, and a left-side second clearance CL2B provided between the second contact portion 74A on the left side and the inner wall of the second through hole 55B on the left side. As shown in FIG. 14, the second clearance CL2 is set to be small compared to the first clearance CL1. Therefore, it becomes difficult for the second unit 50B to move in the left-right direction with respect to the assembly member 60 compared to the first unit 50A.

As shown in FIG. 12, a fourth clearance CL4 is provided, in the up-down direction, between the second extension portion 72 and the second through hole 55B. In detail, an upper-side fourth clearance CL4A is provided between an upper surface of the second extension portion 72 and the inner wall of the second through hole 55B on the upper side. A lower-side fourth clearance CL4B is provided between a lower surface of the second extension portion 72 and the inner wall of the second through hole 55B on the lower side. The fourth clearance CL4 combines the upper-side fourth clearance CL4A and the lower-side fourth clearance CL4B. As shown in FIG. 14, the fourth clearance CL4 is set to be large compared to the second clearance CL2. On the other hand, as stated above, a fifth clearance (not illustrated) has a size the same as the size of the third clearance CL3 in the up-down direction between each of the third projections 81 and each of the third through holes 55C, and is set to be smaller than the fourth clearance CL4. Accordingly, the length that the second unit 50B can move relative to the assembly member 60 in the up-down direction is prescribed by the fifth clearance (the same length as the third clearance CL3). Accordingly, it becomes difficult for the second unit 50B to move in the up-down direction with respect to the assembly member 60.

### Actions and Effects of the Embodiment

According to the embodiment, the following actions and effects are accomplished.

A wiring module 20 relating to the embodiment is a wiring module 20 attached to a battery laminate body 11L formed by laminating a plurality of power storage elements (lamination type battery 11) each including an electrode terminal (electrode lead 12), the wiring module 20 including: a plurality of conductive members (terminal 30 and busbar 40) electrically connected to the electrode terminals, a protector 50 including a first unit 50A and a second unit 50B formed as a separate body from the first unit 50A, the protector 50 holding the plurality of conductive members, and an assembly member 60, in which the first unit 50A and the second unit 50B are coupled to one another in a slidably movable manner in a lamination direction (left-right direction) in which the power storage elements are laminated, the assembly member 60 is assembled with both the first unit 50A and the second unit 50B in a first direction (front-rear direction) orthogonal to the lamination direction, the first unit 50A, the second unit 50B, and the assembly member 60 each have a facing surface, the facing surface (front surface 50AS) of the first unit 50A and the facing surface (rear surface 60S) of the assembly member 60 face one another in the first direction, the facing surface (front surface 50BS) of the second unit 50B and the facing surface of the assembly member 60 face one another in the first direction, one of the first unit 50A and the assembly member 60 includes a first projection 61 that projects from the facing surface in the first direction, a first through hole 55A into which the first projection 61 is inserted is formed in the other one of the first unit 50A and the assembly member 60, one of the second unit 50B and the assembly member 60 includes a second projection 71 that projects from the facing surface in the first direction, a second through hole 55B into which the second projection 71 is inserted is formed in the other one of the second unit 50B and the assembly member 60, the first projection 61 includes a first contact portion 64A that faces an inner wall of the first through hole 55A in the lamination direction, and a first clearance CL1 is set between the first contact portion 64A and the inner wall of the first through hole 55A.

According to such a configuration, by having the first clearance CL1 set between the first contact portion 64A of the first projection 61 and the inner wall of the first through hole 55A, the first unit 50A can be slidably moved with respect to the assembly member 60 in the lamination direction. Accordingly, even in the case where the assembly member 60 is assembled with the protector 50, it is easy to allow the first unit 50A and the second unit 50B to slidably move with respect to one another in the lamination direction.

In the embodiment, the assembly member 60 includes the first projection 61 and the second projection 71, the first through hole 55A is formed in the first unit 50A, and the second through hole 55B is formed in the second unit 50B.

According to such a configuration, since the first unit 50A and the second unit 50B do not include a projection, work of assembling the conductive member with the first unit 50A and the second unit 50B is not hindered.

In the embodiment, the second projection 71 includes a second contact portion 74A disposed facing an inner wall of the second through hole 55B in the lamination direction, a second clearance CL2 is set between the second contact portion 74A and the inner wall of the second through hole 55B, and the second clearance CL2 is smaller than the first clearance CL1.

According to such a configuration, by having the second clearance CL2 set to be smaller than the first clearance CL1 between the second contact portion 74A of the second projection 71 and the inner wall of the second through hole 55B, it is difficult for the second unit 50B to slidably move with respect to the assembly member 60 in the lamination direction compared to the first unit 50A. In this way, it is easy to position the assembly member 60 with the protector 50.

In the embodiment, the first projection 61 includes a first extension portion 62 that extends from the facing surface in the first direction, and a first enlarged diameter portion 63 that projects from the first extension portion 62 in a direction orthogonal to the first direction, the first enlarged diameter portion 63 being disposed on a tip end portion of the first extension portion 62, the first enlarged diameter portion 63 includes a first locking portion 66A that locks with a hole edge portion of the first through hole 55A in the first direction, the second projection 71 includes a second extension portion 72 that extends from the facing surface in the first direction, and a second enlarged diameter portion 73 that projects from the second extension portion 72 in a direction orthogonal to the first direction, the second enlarged diameter portion 73 being disposed on a tip end portion of the second extension portion 72, and the second enlarged diameter portion 73 includes a second locking portion 76A that locks with a hole edge portion of the second through hole 55B in the first direction.

According to such a configuration, by having the first locking portion 66A and the hole edge portion of the first through hole 55A locked together, the first projection 61 can be restrained from falling outside of the first through hole 55A. By having the second locking portion 76A and the hole edge portion of the second through hole 55B locked together, the second projection 71 can be restrained from falling outside of the second through hole 55B.

In the embodiment, a direction orthogonal to both the first direction and the lamination direction is set as a second direction (up-down direction), and a dimension of the first through hole 55A in the second direction is smaller than a dimension of the first through hole 55A in the lamination direction.

According to such a configuration, by making a dimension of the first through hole 55A smaller in a second direction orthogonal to the lamination direction that provides the first clearance CL1, the first locking portion 66A and the hole edge portion of the first through hole 55A become easily locked together.

In the embodiment, the first enlarged diameter portion 63 projects from the first extension portion 62 in the second direction, and is disposed more inward than the first extension portion 62 in the lamination direction.

According to such a configuration, in the case where the first enlarged diameter portion 63 projects in the lamination direction, it is necessary to increase a projection amount of the first enlarged diameter portion 63 from the first extension portion 62 by the amount of the first clearance CL1. However, in the above configuration, since the first enlarged diameter portion 63 does not project from the first extension portion 62 in the lamination direction, and projects in the second direction, a projection amount of the first enlarged diameter portion 63 from the first extension portion 62 can be reduced, and the first enlarged diameter portion 63 can be made smaller.

In the embodiment, the first enlarged diameter portion 63 is a pair of first bending pieces 66 that extend from the first extension portion 62 on both sides in the second direction, and the pair of first bending pieces 66 are elastically deformable in the second direction.

According to such a configuration, the first projection 61 is easily inserted into the first through hole 55A.

In the embodiment, the first projection 61 has a first bending space 66B between the pair of first bending pieces 66, the first bending space 66B allowing the pair of first bending pieces 66 to bend.

According to such a configuration, by having the first bending space 66B provided, the first bending piece 66 becomes easily bent, and furthermore, the first projection 61 becomes easily inserted into the first through hole 55A.

In the embodiment, the plurality of conductive members include a busbar 40, and only one of the first unit 50A and the second unit 50B includes a busbar holding portion 53 that holds the busbar 40.

Since the busbar 40 in which a large current flows easily generates heat, a material with a high heat resistance is used for the protector 50 that includes the busbar holding portion 53. According to such a configuration, by using a material with a high heat resistance in only the one of the first unit 50A and the second unit 50B that includes the busbar holding portion 53, and using an inexpensive material with a normal heat resistance in the other one of the first unit 50A and the second unit 50B that does not include the busbar holding portion 53, the manufacturing cost of the protector 50 can be reduced.

### Other Embodiments

(1) In the above embodiment, while the present disclosure has a configuration in which the assembly member 60 includes the first projection 61 and the second projection 71, the first unit 50A has the first through hole 55A, and the second unit 50B has the second through hole 55B, the present disclosure is not limited to this. For example, the present disclosure may have a configuration in which the assembly member has the first through hole and the second through hole, the first unit includes the first projection, and the second unit includes the second projection.
(2) In the above embodiment, while the assembly member 60 is a cover, the present disclosure is not limited to this, and the assembly member may be a member having a usage different than that of a cover.

### LIST OF REFERENCE NUMERALS

10 power storage module
11 lamination type battery
11L battery laminate body
12 electrode lead
12A connection electrode lead
12B output electrode lead
13 joint portion
14 output portion
15 casing
15A bottom portion
15B ceiling portion
15C side portion
20 wiring module
30 terminal
31 main body portion
32 connection portion
34 wiring connection portion
40 busbar
40A first portion
40B second portion
41 busbar side connection portion
41A insertion hole
50 protector
50A first unit
50AS front surface
50B second unit
50BS front surface
51 slide structure
51A convex portion
51B concave portion
52 electrode housing concave portion
52A connection electrode housing concave portion
52B output electrode housing concave portion
53 busbar holding portion
53A bolt fastening portion
54 terminal housing portion
55A first through hole
55B second through hole
55C third through hole
56 wiring concave portion
60 assembly member
60S rear surface
61 first projection
62 first extension portion
63 first enlarged diameter portion
64 first column portion
64A first contact portion
65 first beam portion
66 first bending piece
66A first locking portion
66B first bending space
71 second projection
72 second extension portion
73 second enlarged diameter portion
74 second column portion
74A second contact portion
75 second beam portion
76 second bending piece
76A second locking portion
76B second bending space
81 third projection
CL1 first clearance
CL1A right-side first clearance
CL1B left-side first clearance
CL2 second clearance
CL2A right-side second clearance
CL2B left-side second clearance
CL3 third clearance
CL3A upper-side third clearance
CL3B lower-side third clearance
CL4 fourth clearance
CL4A upper-side fourth clearance
CL4B lower-side fourth clearance

1. A wiring module to be attached to a battery laminate body formed by laminating a plurality of power storage elements each including an electrode terminal, the wiring module comprising:
a plurality of conductive members electrically connected to the electrode terminals;
a protector including a first unit and a second unit formed as a separate body from the first unit, the protector holding the plurality of conductive members; and
an assembly member, wherein
the first unit and the second unit are coupled to one another in a slidably movable manner in a lamination direction in which the power storage elements are laminated,
the assembly member is assembled with both the first unit and the second unit in a first direction orthogonal to the lamination direction,
the first unit, the second unit, and the assembly member each have a facing surface,
the facing surface of the first unit and the facing surface of the assembly member face one another in the first direction,
the facing surface of the second unit and the facing surface of the assembly member face one another in the first direction,
one of the first unit and the assembly member includes a first projection that projects from the facing surface in the first direction,
a first through hole into which the first projection is inserted is formed in the other one of the first unit and the assembly member,
one of the second unit and the assembly member includes a second projection that projects from the facing surface in the first direction,
a second through hole into which the second projection is inserted is formed in the other one of the second unit and the assembly member,
the first projection includes a first contact portion that faces an inner wall of the first through hole in the lamination direction, and
a first clearance is set between the first contact portion and the inner wall of the first through hole.

2. The wiring module according to claim 1, wherein
the assembly member includes the first projection and the second projection,
the first through hole is formed in the first unit, and
the second through hole is formed in the second unit.

3. The wiring module according to claim 1, wherein
the second projection includes a second contact portion disposed facing an inner wall of the second through hole in the lamination direction,
a second clearance is set between the second contact portion and the inner wall of the second through hole, and
the second clearance is smaller than the first clearance.

4. The wiring module according to claim 1, wherein
the first projection includes a first extension portion that extends from the facing surface in the first direction, and a first enlarged diameter portion that projects from the first extension portion in a direction orthogonal to the first direction, the first enlarged diameter portion being disposed on a tip end portion of the first extension portion,
the first enlarged diameter portion includes a first locking portion that locks with a hole edge portion of the first through hole in the first direction,
the second projection includes a second extension portion that extends from the facing surface in the first direction, and a second enlarged diameter portion that projects from the second extension portion in a direction orthogonal to the first direction, the second enlarged diameter portion being disposed on a tip end portion of the second extension portion, and
the second enlarged diameter portion includes a second locking portion that locks with a hole edge portion of the second through hole in the first direction.

5. The wiring module according to claim 4, wherein
a direction orthogonal to both the first direction and the lamination direction is set as a second direction, and
a dimension of the first through hole in the second direction is smaller than a dimension of the first through hole in the lamination direction.

6. The wiring module according to claim 5, wherein
the first enlarged diameter portion projects from the first extension portion in the second direction, and is disposed more inward than the first extension portion in the lamination direction.

7. The wiring module according to claim 6, wherein
the first enlarged diameter portion is a pair of first bending pieces that extend from the first extension portion on both sides in the second direction, and
the pair of first bending pieces are elastically deformable in the second direction.

8. The wiring module according to claim 7, wherein
the first projection has a first bending space between the pair of first bending pieces, the first bending space allowing the pair of first bending pieces to bend.

9. The wiring module according to claim 1, wherein
the plurality of conductive members include a busbar, and
only one of the first unit and the second unit includes a busbar holding portion that holds the busbar.
